(19) United States
(12) Patent Application Publication
(10) Pub. No.: US 2011/0264398 A1
(43) Pub. Date: Oct. 27, 2011

(54) Fibre Optic Sensor System

(76) Inventors: Pawel Niewczas, Glasgow (GB); James R. McDonald, Stewarton (GB)

(21) Appl. No.: 13/124,620

(22) PCT Filed: Oct. 16, 2009
(86) PCT No.: PCT/GB2009/002490

§ 371 Date: Jul. 11, 2011

(30) Foreign Application Priority Data
Oct. 16, 2008 (GB) 0818991.2

(51) Int. Cl. G02B 6/00; B23K 13/01; B32B 37/14; G06F 15/00; B32B 37/06

(52) U.S. Cl. 702/130; 385/13; 156/273.9; 156/379.6; 219/615

(57) ABSTRACT

A combined pressure and temperature sensor, the sensor comprising at least one first optical sensing element of a first type and at least one second optical sensing element of a second type, wherein the sensor is adapted to compensate for temperature and/or pressure effects in the first or second optical sensing element using a response of the other of the second or first optical sensing elements.

### FIELD OF THE INVENTION

The present invention relates to an improved apparatus and method for making measurements. In particular, the present invention relates to a measurement system having a combined pressure and temperature sensor. The present invention also relates to a method of manufacture of the said apparatus.

### BACKGROUND TO THE INVENTION

Monitoring parameters such as pressure and temperature is of importance in many industries, such as the oil and gas, chemical processing, geothermal and conventional energy production, aero and automotive industries. The sensors often have to function in challenging conditions such as high temperature and/or pressure, in areas suffering from a high level of electrical interference and often at great distance from the operator and/or measuring station. Sensors that accurately measure pressure are particularly important in the oil industry, where pressure measurements can be used in “build up” tests, which are used to determine the size of reserves. Inaccuracies in pressure measurement can therefore lead to significant miscalculation of reserves, with associated financial implications.

Types of sensor that are commonly available include electrical and optical sensors. Electrical sensors require a local power supply, which is often difficult to provide in remote or downhole locations. Electrical data transmission is also relatively slow over long distances compared to optical methods and both the data transmission and the sensor itself are subject to electrical interference. Furthermore, electrical sensors may be unreliable in harsh conditions such as high temperatures or in certain chemical environments.

Optical sensors solve many of these problems. Such optical sensors include sensors based on Fibre Bragg gratings and sensors based on Fabry-Perot cavities, both of which produce temperature and pressure dependent optical effects when illuminated by an appropriate source. However, optical sensors often suffer from cross-sensitivity between pressure effects and temperature effects, which may lead to measurement errors. This is particularly problematic in applications where accuracy is important or where both temperature and pressure vary over a wide range.

Sensor systems have been developed to address this problem, based on simultaneous measurement of pressure and temperature. WO2005024365 describes the use of two Fabry-Perot interferometers, one interferometer arranged to be more pressure dependent and the other interferometer arranged to be more temperature dependent. Other examples are described in WO0033046, which discloses a system containing two Fibre Bragg gratings and WO2007109336.

WO2007109336 describes a dual sensor system having a fibre Bragg grating sensor for measuring temperature and a separate Fabry-Perot sensor for measuring pressure, the two sensors being separated by one hundred metre long delay lines to ensure that the signals from each of the sensors do not interfere with one another. Separation of the temperature and pressure sensors may result in errors due to each sensor being located indifferent areas or different regions of the measurement environment. Thus the error due to temperature/pressure cross-sensitivity seen by one sensor cannot be corrected by measurement of pressure and/or temperature obtained by the other.

### SUMMARY OF INVENTION

According to a first aspect of the present invention there is provided a combined pressure and temperature sensor, the sensor comprising at least a first optical sensing element of a first type and at least a second optical sensing element of a second type.

The first optical sensing element may be a pressure-sensing element. The first optical sensing element may be adapted to be more responsive to pressure than the second element. The second optical sensing element may be a temperature-sensing element. The second optical sensing element may be adapted to be more responsive to temperature than the first element

By combining both a pressure-sensing element and a temperature-sensing element into a unitary, hybrid sensor, the sensor can be used to simultaneously measure both the temperature and pressure at the location of the sensor.

By using an optical sensing element to measure pressure that is of a different type to the optical sensing element used to measure temperature, each sensing element produces a different response to varying temperature and/or pressure, such that it is easier to separate out the response of at least one of the sensing elements.

The at least one first optical sensing element may comprise an optical cavity. The optical cavity may be a Fabry-Perot cavity. The at least one second optical sensing element may comprise a Bragg grating or Bragg reflector, which may be a narrow-band Bragg grating or a narrow-band Bragg reflector. The sensor may comprise two or more second optical sensing elements, which may comprise at least one Bragg grating and at least one Bragg reflector.

The sensor may be adapted to compensate for temperature and/or pressure effects in the first or second optical sensing element using a response of the other of the second or first optical sensing elements.

At least one of the first or second optical sensing elements may be a narrow-band optical sensing element. The narrow-band optical sensing element may be arranged to produce a response having a full width half maximum (FWHM) of less than 2 nm and preferably between 0.2 nm and 0.7 nm. In this way, a response of the narrow-band optical sensing element may be more easily extracted from a total sensor response.

The sensor may be adapted to measure temperature and pressure of substantially the same area. The sensing elements may be substantially proximate or adjacent each other. The sensing elements may be connected in series.

The sensor may be adapted to collect data over a continuous spectral range, the spectral range may contain both a spectral range of the first optical sensing element and a spectral range of the second optical sensing element. By collecting the whole spectral response, expensive, complex and/or bulky means for isolating selected spectral regions associated with each sensor, such as pulsed lasers, delay loops and switching means, can be avoided.

The sensor may be arranged to receive light from a light source. The sensor may receive light through a first optical fibre.

At least one of the first sensing element and/or the second sensing element may be arranged to produce a response to temperature and/or pressure in a different wavelength range to the response to temperature and/or pressure produced by the other sensing element. In this way, it is easier to separate the readings of each sensing element. At least one of the responses may be at least one of a distinctive peak or trough in light intensity.

The sensor may be adapted to produce a shift in the wavelength of the response and/or the free spectral range of at least one of the sensing elements that is usable to determine a temperature and/or pressure.

The sensor may comprise at least a first optical fibre and a pressure sensitive housing, the housing defining a cavity, wherein an end of the first optical fibre is located within the cavity. The pressure sensitive housing may be deformable by outside pressure so as to change at least one dimension of the cavity. The end of the first optical fibre may be located such that it faces an end of a second optical fibre and/or a reflective surface so as to form the optical cavity. The housing may be a capillary. The housing may be formed of glass, silicon, ceramic or metal. The capillary may have an outer diameter of 2 mm or less and preferably 1 mm or less.

The first and/or second optical fibre may be bonded to the housing. The bond may be by fusion bonding, brazing, soldering, glass frit bonding or laser welding. The cavity may be sealed. The bond may be realised by induction heating assisted brazing employing metallic heat concentrating elements positioned around the bonded region.

The reflective surface may be a metal surface such as an end of a metal rod.

The housing may be a microelectromechanical system (MEMS) device. The housing may comprise a base layer defining a bore for accommodating at least a portion of the first optical fibre. The bore may form an aperture on a first surface of the base layer. An end of the first optical fibre may be located at the aperture.

The housing may further comprise a spacer layer disposed onto the first surface of the base layer. The spacer layer may define a recess extending part way through a thickness of the spacer layer. A through opening may be located within the recess, the opening being coincident with the aperture in the base layer.

The sensor may further comprise a diaphragm on a surface of the spacer opposite the base layer, the diaphragm closing the recess such that the end of the first optical fibre, the base layer, the spacer and the diaphragm form a sealed cavity.

The surface of the diaphragm facing the end of the first optical fibre may be provided with a reflective surface, so as to form an optical cavity with the end of the optical fibre. The cavity may be a Fabry-Perot cavity. The reflective surface may be a metal or dielectric reflective surface.

The diaphragm may be provided with an antireflective coating on an opposite side to the reflective coating. The antireflective coating may be a roughened or angle ground surface of the diaphragm. The base layer and/or spacer and/or diaphragm may be constructed from silicon or borosilicate glass.

The base layer and/or spacer and/or diaphragm may be bonded together. The bonding may be thermocompression bonding, electric field assisted bonding, glass or polymer adhesive bonding. One or more of the layers may be integral with each other.

The optical cavity may be arranged to have a low reflectivity. The optical cavity may be arranged to have a low reflectivity relative to the fibre Bragg grating. The reflectivity of the cavity may be 8% or less. This advantageously minimises the effect of the optical cavity on the Fibre Bragg grating or Bragg reflector and thereby minimises interference between the two sensors.

The fibre Bragg grating and/or Bragg reflector may be formed in, or on, a portion of the first or second glass fibres.

At least one of the temperature sensing elements may be located external to and adjacent the housing. By locating the temperature-sensing element outside the housing of the sensor, the temperature-sensing element will be in better contact with the surrounding fluid and thereby have improved temporal response to temperature changes.

At least one of the temperature sensing elements may be located within the housing. By locating at least one temperature-sensing element within the housing, the temperature-sensing element is at least partially shielded from the influence of changing pressure, as the housing is sealed at a specified pressure. This simplifies the calibration process and reduces errors due to changing pressure.

The sensor may comprise two or more temperature sensing elements. At least one of the temperature sensing elements may be located within the housing and at least one of the temperature sensing elements may be located outside the housing. A Bragg reflector may be deposited on the end of the first or second optical fibre forming the optical cavity. At least one Bragg reflector may be provided on another end of at least one of the optical fibres.

The Bragg reflector may comprise alternate layers of at least two different dielectric materials. The dielectric materials may be silicon nitride and silicon reach silicon nitride.

The housing and/or at least one of the optical fibres may have a water resistant coating, such as a polyiamide coating. The water resistant coating prevents ingress of water into the optical fibre, which may degrade the optical fibre and thereby affect the measurement. Polyiamide is stable to reasonably high temperatures, however, a skilled person would appreciate that other coating materials could be used, especially at lower temperatures. The fibres may be metal coated. Metal coated fibres may be brazed or soldered to a metal housing or to a glass housing or capillary having metal coated ends. Brazing may be realised by induction heating assisted brazing employing metallic heat concentrating elements positioned around the bonded region.

The housing and/or reflective surface and/or optical fibre and/or metal rod may be adapted such that the cavity length remains substantially unchanged with varying temperature. Adaptation of the metal rod may be by thermal treatment and/or by selection of an appropriate composition for the rod.

According to a second aspect of the present invention is a system comprising a light source and/or a sensor interrogation system and a sensor according to the first aspect.

The detector may be a tuneable detector or a separate tuneable filter and photodetector,

The light source and sensor may be linked by optical fibre, which may be the first optical fibre. The light source may be a broadband light source, for example a superluminescent diode or a superfluorescent source.

The light source may be a non-pulsed light source. The system may be arranged such that light reflected by the sensor is returnable by the first optical fibre and directed to a scanning filter and detector via a directional coupler to be analysed spectrally. By using a broadband light source, the system of the present invention is cheaper to produce than systems that require use of a laser or other expensive light source.

The sensor interrogation system may be adapted to compensate for temperature and/or pressure effects in the first or second optical sensing element using a response of the other of the second or first optical sensing elements.

The sensor interrogation system may be adapted to deconvolute the responses of each sensing element via an algorithmic compensation technique and/or model fitting and/or curve fitting.

The sensor interrogation system may be adapted to suppress a response produced by one of the first and/or second sensing elements to produce a modified response and may determine pressure and/or temperature based on the modified response. The response may be suppressed in a wavelength window. The modified response may span a range of wavelengths larger than that of the suppressed wavelength window.

The system may be adapted to measure a continuous spectral range that may include spectral ranges of both the first and second optical sensing elements. By using a non-pulsed light source, the complexity and cost of the sensor interrogation system is reduced and more data can be collected in an equivalent timeframe or a similar measurement can be collected in a reduced timeframe.

The system may further comprise a processor and memory. The memory may be adapted to store a look up table. The look up table may contain calibration data for recovering both temperature and pressure.

The system may include a connection box, for protecting an optical splice.

The system may be further adapted to separate responses of at least one first sensing element from the responses of at least one second sensing element. Separating the responses of the first and second sensing elements may include deconvoluting the signals and/or using algorithmic compensation techniques and/or model fitting and/or curve fitting. This allows more accurate separation of the effects due to each sensing element and thereby more accurate determination of temperature and pressure. This also allows the system to be used with optical cavities having high reflectivity, such as those having metallic or dielectric mirrors deposited inside the cavity.

The system may be adapted to determine the influence of the first or second sensing element on the other by comparing the experimental data to calibration or modelled data.

The system may be adapted to deconvolute the responses of each sensing element. The deconvolution may be via an algorithmic compensation technique. The system may be adapted to capture a combined spectrum from at least two sensing elements. The system may employ an algorithmic technique to suppress the response of at least one of the sensing elements in order to determine the response of at least one other of the sensing elements. The algorithmic technique may include a curve fitting algorithm.

According to a third aspect of the present invention is a method for determining temperature and/or pressure at a location, comprising providing a sensor unit of the first aspect at a location, measuring a response of the sensor unit indicative of temperature and/or pressure, and extracting a response produced by the first optical sensing element and/or a response produced by the second optical sensing element.

The first optical sensing element may be a pressure-sensing element. The second optical sensing element may be a temperature-sensing element.

The method may further comprise using the extracted response produced by the optical pressure sensing element or the optical temperature sensing element to compensate for pressure or temperature effects on the other of the temperature or pressure sensing element.

The method may further comprise determining the influence of one the first or second sensing element on the other of the first or second sensing element by comparing the experimental data to calibration or modelled data.

The method may further comprise deconvoluting the responses of each sensing element. The deconvolution may be via an algorithmic compensation technique. The method may comprise capturing a combined spectrum from at least two sensing elements and employing an algorithmic technique to suppress the response of at least one of the sensing elements in order to determine the response of at least one other of the sensing elements. The algorithmic technique may include a curve fitting algorithm.

According to a fourth aspect of the present invention is a computer program product adapted to implement a sensor of the first aspect or a system of the second aspect and/or implement a method of the third aspect.

According to a fifth aspect of the present invention is a method of bonding at least a first member to at least a second member, the method comprising providing bonding material in a bonding region between at least a portion of the first member and at least a portion of the second member, providing an induction-heating element proximate the bonding region and heating the induction-heating element using inductive heating to bond the first member to the second member.

The bonding may comprise brazing and the bonding material may be a brazing material. The bonding material may comprise metal paste or glass frit.

The first and/or second member may comprise an optical fibre and/or a wire and/or a pressure sensitive housing and/or a capillary. The induction heating element and/or the bonding region may be sized so that heating by the metallic induction heating element and/or bonding is substantially localised to the bonding region. The induction heating element may be substantially the same size as the bonding region.

The optical fibre may be a metallic coated optical fibre. The wire may be a metallic wire.

The method may comprise providing a bench, which may be a ceramic bench, such as a supported ceramic bench. The bench may comprise grooves for accommodating the first and/or second members. The grooves may be machined grooves.

The bench may comprise slots for accommodating at least one induction-heating element. The slots may be machined slots.

The induction-heating element may be metallic. The induction-heating element may have a volume of at least 100 mm³ and preferably at least 200 mm³. The induction-heating element may be inductively heatable by an induction source, which may comprise a coil. The coil may be positioned or positionable proximate and/or around the induction-heating element.

The coil may be arranged to receive an alternating current signal from a current source. The current may be a high frequency current, which may have frequencies of less than 1 MHz, preferably less than 400 kHz and most preferably between 300 and 400 kHz. The frequency of current flowing through the coil may be chosen so as to induce heat only in the heat concentrator and not in the capillary or metal-coated fibre. Low frequency magnetic fields may penetrate deeper into a metallic element, and so the frequency may be chosen such that the field passes through the fibre coating and capillary wall depths without significant eddy current generation but may generate significant eddy currents in a more bulky induction-heating element.

The induction-heating element is arranged to surround the first and/or second members. The induction-heating element may be provided with a passage for receiving the optical fibre and/or wire and/or object. The induction-heating element may be provided in two or more pieces, which may be separable. In this way, the first and/or second members may be easily placed within the passage of the induction-heating element.

The induction-heating element may be adapted to be heated by eddy currents generated by the changing magnetic filed resulting from the high frequency current flowing through the coil. As a result, brazing material or glass frit may melt under the heat generated by the induction-heating element and the melted material may react with the inner surface of the capillary and the metal-coated fibre, which may form a strong bond after cooling.

Inert gas such as argon or nitrogen may be provided at the area where heating takes place. Thereby, oxidisation of the first and/or second member may be reduced.

Two or more induction-heating elements may be provided. In this way, heating of multiple locations, such as both ends of a capillary may be carried out at the same time.

One or more micro-positioning manipulators may be provided, which may be operable to hold optical fibres and/or wire to assist in inserting the fibre and/or wire in the capillary and moving them to the required depth. Two or more micro-positioning manipulators may be provided. Furthermore, the system may be operable to fabricate multiple sensor elements by providing two or more ceramic benches and/or multiple heat concentrating elements, which may be heatable with just one induction coil.

According to a sixth aspect of the present invention is a method of fabricating an optical sensing element according to the first aspect comprising bonding at least a portion of at least one optical fibre and/or wire to a pressure sensitive housing the method of the fifth aspect.

According to a seventh aspect of the present invention is apparatus for performing the method of the fifth and/or sixth aspects, the apparatus comprising an induction-heating element defining a passage for receiving at least a section of an optical fibre and/or a wire and/or a capillary, and an induction source for causing heating of the induction-heating element by induction.

The induction-heating element may be adapted to be heated by eddy currents generated by the changing magnetic field resulting from the high frequency current flowing through the coil.

The induction-heating element may be metallic. The induction-heating element may be provided in two or more pieces.

The apparatus may comprise a bench, which may be a ceramic bench. The bench may comprise grooves and/or slots to accommodate the optical fibre and/or wire and/or the object. The bench may comprise slots for accommodating at least one induction-heating element.

The apparatus may be provided with a source of inert gas such as argon or nitrogen at the area where heating takes place.

Two or more induction-heating elements may be provided.

One or more micro-positioning manipulators may be provided, which may be operable to hold optical fibres and/or wire to assist in inserting the fibre and/or wire in the capillary and moving them to the required depth. Furthermore, the system may be operable to fabricate multiple sensor elements by providing two or more ceramic benches and multiple heat concentrating elements heated with just one induction coil.

According to an eighth aspect of the invention is a method of sealing a sensor according to the first aspect within a plug using the method of the fifth aspect.

The plug may be a metal plug. The plug may be adapted for securing in a port of a pressurised system using a gland. A protruding end of the plug may be drilled to accommodate a metal-coated fibre. The metal-coated fibre may form a pigtail of the sensor. Brazing material may be applied to the drilled hole and the fibre. The protruding end may be heated using an induction-heating element arranged around a section of the protruding end. The induction-heating element may be heated via induction heating methods, e.g. using a coil carrying a high-frequency current. The melted brazing material may bond to the plug and the fibre and form a high-pressure seal upon cooling. The seal may be a metallic seal.

An advantage of the 5^{th} to 8^{th} aspects of the invention is that heat is applied to a precisely defined region of the capillary or a section of the plug, marked out by the geometry of induction-heating element(s). This limits the temperature experienced by the adjacent FBG transducer (or the combined sensor), which may otherwise be damaged if it was heated to the same temperature as the heated section.

Another advantage is that the induction-heating elements may be in the form of two or more separable segments, and so they can be easily put in place around a section to be heat processed and then removed without the need to move the sensor assembly. This may prevent the FP cavity length, precisely set up between the fibre ends or between one fibre end and one reflecting wire end, from being changed during such manipulation. Such a change of cavity length may affect the repeatability of the results. In addition, such arrangement facilitates easier application of brazing material or glass frit. Such bonding or sealing materials can be applied prior to setting up the induction-heating element. Another advantage is that only the desired sections of a sensor are heated and the reminder of the set-up, particularly the micro-positioners, remain in ambient temperature, preventing any misalignment and damage to the micropositioners. Yet another advantage is that the induction-heating element(s) may be drilled and a thermocouple may be inserted to measure temperature of the induction-heating elements) and hence the temperature of the heating process. The precise knowledge of this temperature may be important in controlling the high-frequency current supply to the induction source so that an optimal temperature can be reached in a relatively short time to melt brazing material or glass frit, whilst ensuring that the temperature is not high enough to cause damage to the fibre coating.

Furthermore, the size of the heat concentrator may be sufficient to measure its temperature using a laser pyrometer, which is a non-contact temperature measurement. A laser pyrometer may then be used instead of a thermocouple to determine the process temperature and convey this information to a current source controller to control the current applied to the induction source accordingly. As the pyrometer may be focussed around the passage accommodating the capillary in the induction-heating element(s), temperature measurement of the heating process may be more accurate.

### DESCRIPTION OF THE DRAWINGS

Various aspects of the invention will now be described by way of example only and with reference to the accompanying drawings of which:

FIG. 1 is a schematic of a sensor system;

FIG. 2(a) is a detailed view of a combined sensor for use in the system of FIG. 1;

FIG. 2(b) shows an alternate embodiment of a combined sensor for use in the system of FIG. 1;

FIG. 3 shows a connection box, protection and an enclosure for the sensor element of the system of FIG. 1;

FIG. 4(a) is a normalised reflection spectrum taken using the system of FIG. 1 at a pressure of OMpa (Opsi) and a temperature of 0° C.;

FIG. 4(b) is a normalised reflection spectrum taken using the system of FIG. 1 at a pressure of 20.684 Mpa (3000 psi) and a temperature of 0° C.;

FIG. 4(c) is a normalised reflection spectrum taken using the system of FIG. 1 at a pressure of OMpa (Opsi) and a temperature of 300° C.;

FIG. 4(d) is a normalised reflection spectrum taken using the system of FIG. 1 at a pressure of 20.684 Mpa (3000 psi) and a temperature of 300° C.;

FIG. 5 shows a total response taken using the system of FIG. 1 and indicating a true position of a FBG peak;

FIG. 6(a) shows a total response of the system of FIG. 1;

FIG. 6(b) shows the response of FIG. 6(a) but with the contribution of the FBG suppressed;

FIG. 6(c) shows a FP response determined from the response of FIG. 6(b);

FIG. 6(d) shows a FBG response determined using the total response of FIG. 6(a) and the FP response of FIG. 6(c);

FIG. 7 shows an alternate embodiment of a combined sensor for use in the system of FIG. 1;

FIG. 8 shows a further alternate embodiment of a combined sensor for use in the system of FIG. 1;

FIG. 9 shows a further alternate embodiment of a combined sensor for use in the system of FIG. 1;

FIG. 10 shows a further alternate embodiment of a combined sensor for use in the system of FIG. 1;

FIG. 11 shows a further alternate embodiment of a combined sensor for use in the system of FIG. 1;

FIG. 12 shows a further alternate embodiment of a combined sensor for use in the system of FIG. 1;

FIG. 13 is a MEMS sensor for use with the system of FIG. 1;

FIG. 14 is an illustration of a method of manufacture of a combined sensor;

FIG. 15 is an illustration of the use of a micro-positioning manipulator used with the method;

FIG. 16 is an illustration of an alternative method of manufacture of a combined sensor;

FIG. 17 is an illustration of yet another alternative method of manufacture of a combined sensor;

FIG. 18 is an illustration of a method of simultaneous manufacture of two combined sensors; and

FIG. 19 is an illustration of a method of sealing the combined sensor within a metal plug.

### SPECIFIC DESCRIPTION

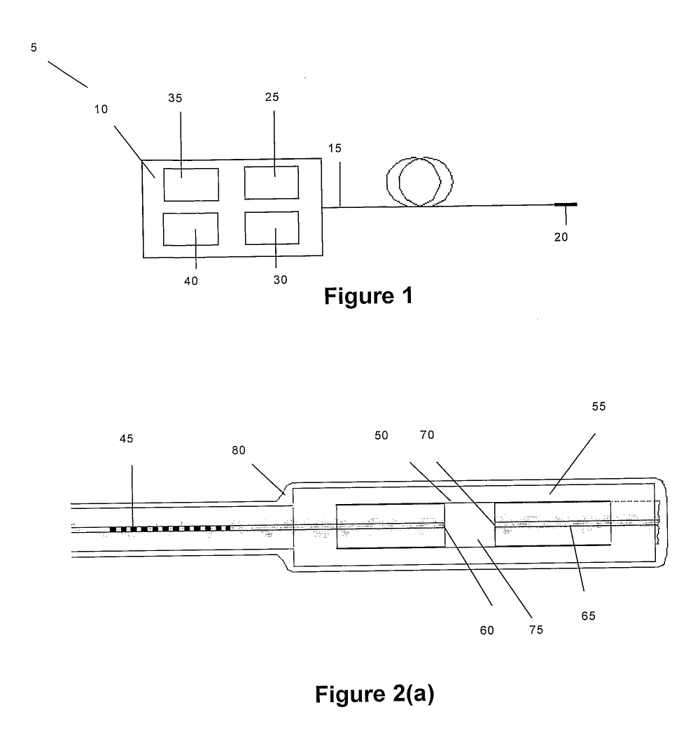

FIG. 1 shows a measurement system 5 having a sensor interrogation system 10 connected by a first optical fibre 15 to a combined pressure and temperature sensor 20. The sensor interrogation system 10 comprises a broadband light source 25 such as a superluminescent diode or a superfluorescent source. The system 5 is arranged such that, in use, sensor 20 receives light from the light source 25 through first optical fibre 15. The interrogation system 10 also comprises a spectral scanning filter, detector 30, processor 35 and memory 40. Optionally, a tuneable detector is used instead of the scanning filter and detector. As a further option, a tuneable laser is used with the detector to capture the entire spectrum rather than the broadband light source and scanning filter.

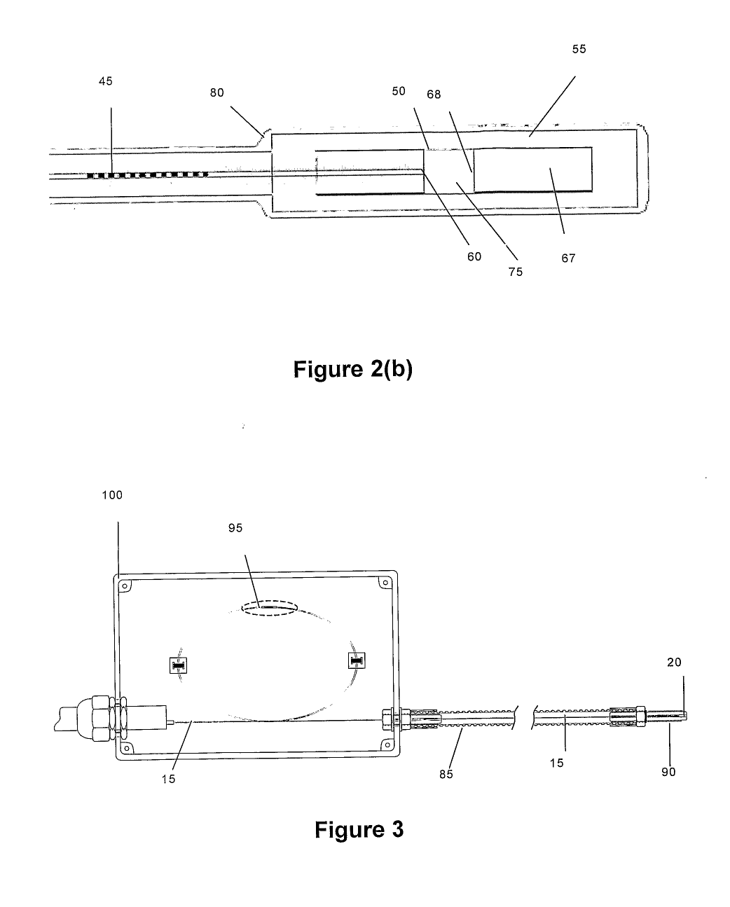

As shown in FIG. 2(a), the dual temperature and pressure sensor 20 comprises a narrow band fibre Bragg grating (FBG) 45 embedded in first optical fibre 15. The narrowband FBG is arranged to produce a response having a full width half maximum (FWHM) in the range of 0.2 nm to 0.7 nm.

The first optical fibre 15 is bonded into a cavity 50 defined by a pressure sensing capillary 55 located adjacent to the FBG 45. The first optical fibre 15 is cleaved such that it has an end 60 within the cavity 50. A second optical fibre 65 is bonded into an opposite end of the cavity 50 of the capillary 55. The second optical fibre 65 has a cleaved end 70, which is located opposite and parallel with the cleaved end 60 of the first optical fibre 15 to form a Fabry-Perot (FP) cavity 75.

In an optional embodiment, the optical fibres 15, 65 may be metal coated. Optionally, the metal coating of the fibres 15, 65 may extend right to the ends of the fibres 15, 65 or it may be removed in sections near the ends of the fibres 15, 65. In embodiments where the capillary 55 and/or fibres 15 or 65 (if not already metal coated) comprise glass or ceramic, the capillary 55 and/or fibres 15 or 65 may be polyiamide coated. The first optical fibre 15 is also provided with suitable metal armour 85, as shown in FIG. 3.

The capillary 55 is formed of glass, ceramic or metal.

The sensor 20 is such that the FBG 45 and FP cavity 75 are arranged in series. The FP cavity 75 has a low reflectivity, which minimises the response of the FP cavity 75 relative to that of the FBG 45. This minimises the effect of the FP cavity 75 on the response of the FBG 45.

In an embodiment, as shown in FIG. 2(b), the capillary 55 is a metal capillary. In the embodiment of FIG. 2(b), a metal rod or wire 67 is used in place of the second optical fibre 65 of FIG. 2(a), and a polished end 68 of the metal rod 67 forms one half of the FP cavity 75. The composition of the metal rod is selected such that the cavity 75 length remains substantially unchanged over the operational temperature irrespective of the thermal expansion and contraction of the rod and capillary 55.

The integrated sensor 20 is contained within an enclosure 90 formed of metal or ceramic. The enclosure 90 can be shaped to fit into a pressure measurement port. The first optical fibre 15 is bonded to the enclosure 90 using techniques such as brazing, soldering, glass frit bonding or high temperature cement. In an optional embodiment, optical connector(s) (not shown) are used to join the sensor's first optical fibre 15 to a further optical fibre or fibres connected to the interrogation system 10. If a suitable optical connector cannot be used, then a splice 95 between the optical fibres can be provided. A connection box 100 can be used, as shown in FIG. 3, to provide protection for the splice 95.

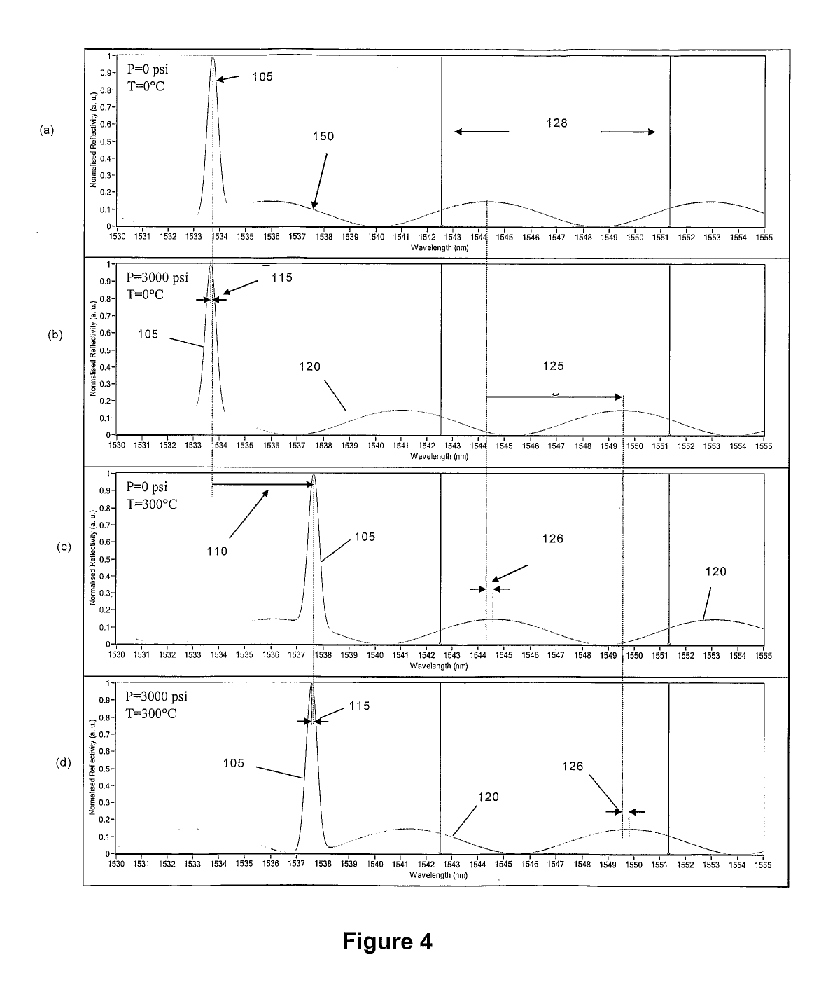

The FBG 45 produces an interference pattern having a distinctive peak 105 that shifts 110 primarily with changing temperature, as can be seen by comparing FIGS. 4(a) and 4(c). The FBG 45 response also exhibits a small pressure sensitive shift 115, as shown in a comparison of FIGS. 4(a) and 4(b). The FP cavity 75 produces a sine wave like reflection signal 120 defined by an Airy function, as shown in FIGS. 4(a) to (d). The response 120 of the FP cavity 75 shifts 125 primarily with changing pressure, as shown by a comparison of FIG. 4(a) with FIG. 4(b) or FIG. 4(c) with FIG. 4(d). To a lesser extent, the free spectral range of the FP cavity 75 also changes 126 with changing temperature. The extent of these responses depends on factors such as the mechanical and thermal expansion properties of the capillary 55 and/or the optical fibres 15, 65. Thus the hybrid temperature/pressure sensor 20 comprises a sensing element, the FBG 45, which varies primarily with temperature and a different type of sensing element, the FP cavity 75, which varies primarily with pressure. In an optional embodiment, either one or both of the ends 60, 70 of each of the optical fibres 15, 65 can be provided with a reflective coating, such as a metallic or dielectric mirror coating, such that the reflectivity of the FP cavity 75 is increased in order to increase the signal 120 intensity produced by the FP cavity 75.

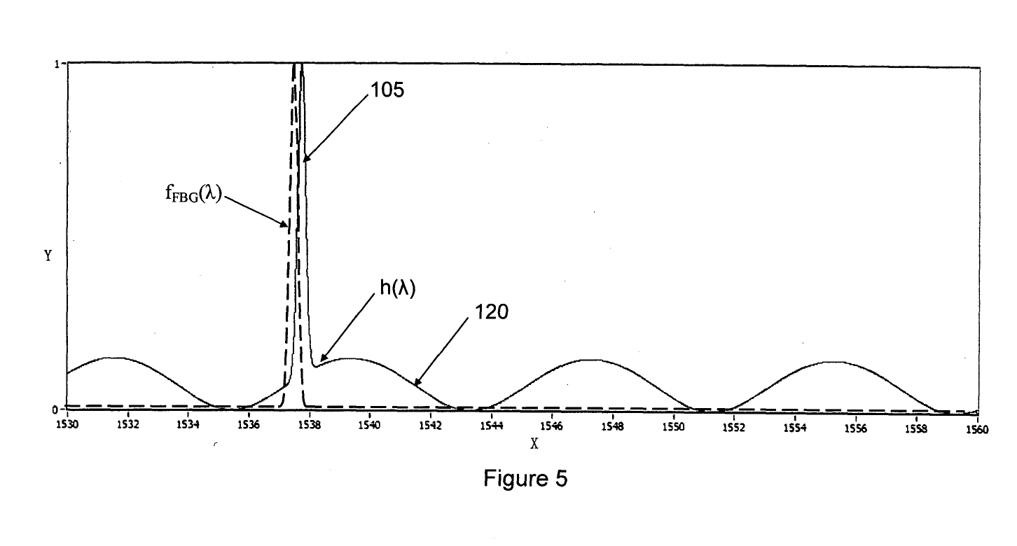

As can be seen from the reflectivity spectra of FIGS. 4(a) to 4(d), the FBG peak 105 and the FP reflection pattern 120 only interfere in the spectral region where the FBG peak 105 is present. Whilst this has no effect on the FP reflection pattern 120 outside the region where the FBG peak 105 is present, the FBG peak position of the combined signal may change depending on the relative positioning of the FBG peak 105 and fringes in the FP reflection pattern 120. This is illustrated in FIG. 5, which shows an exaggerated effect of the apparent FBG peak position shift of the combined signal, h(λ), due to the fact that the FBG peak, f_{FBG}(λ), is positioned on the side of an FP fringe. Depending on the relative amplitude difference between the FP and FBG responses and the FBG peak width, this effect may be more or less severe, and in some cases may be as large as 20 pm or more, equivalent to ˜2° C. or more. Moreover, this error fluctuates from 0, where the FBG peak is aligned with the FP fringe peak or trough, to a maximum level, where the FBG peak is at either side of an FP fringe. This effect may be undesirable because it may affect the temperature reading from the FBG and prevents accurate temperature compensation of the pressure reading from the FP sensor.

To prevent the influence of the FBG spectral response on the FP reading, the measurement system may optionally be adapted to use two separate observation windows, one covering a spectral region containing the peak 105 produced by the FBG 45 and the other window 128 covering a spectral region containing the signal 120 produced by the FP cavity but with no significant contribution by the FBG peak 105. In this way, it is possible to separate out the signal produced by the FP cavity 75 from that produced by the FBG 45.

In addition to the above effects, in order to eliminate the FBG peak 105 position change due to FP fringe 120 movement, the measurement system 5 is provided with appropriate processor 35 and memory 40 modules, shown in FIG. 1, adapted to implement a range of methods of separating the signals from each sensing element 45, 75. In one such method, a calibration step is performed, in which the shift in the FBG peak 105 due to FP fringe 120 movement is observed under a range of controlled conditions. Alternatively, modelling techniques can be used to predict the effect of the FP fringe 120 movements. In either case, calibration shift data or modelled data can be used to subtract any FP shift effects from the FBG data to provide additional decoupling of the FBG and FP effects 105, 120.

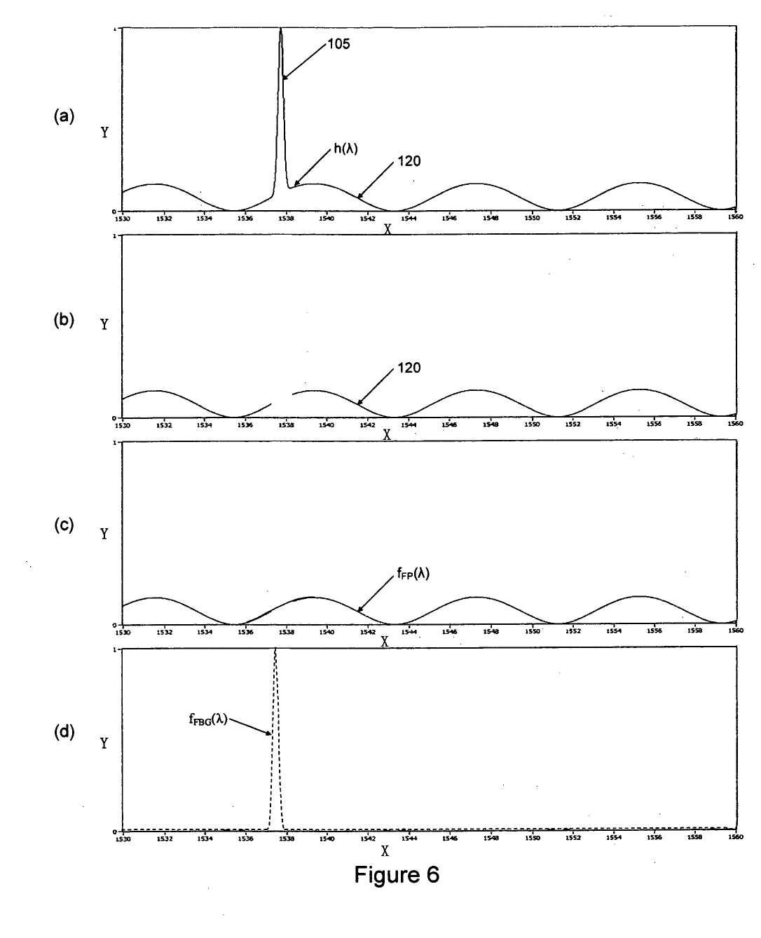

Alternatively or additionally, an algorithmic compensation technique is employed to deconvolute the responses 105, 120 from the FBG 45 and FP cavity 75. This method, illustrated in FIGS. 6(a) to 6(f), involves first capturing the combined spectrum, h(λ), containing both the FBG and FP responses 105, 120, as shown in FIG. 6(a). Algorithmic methods, such as peak detection algorithms, are used to locate an FBG response 105 within the combined spectrum. A known spectral width of the FBG response 105 is then removed from the combined spectral data, thus the FBG response 105 is completely suppressed, as shown in FIG. 6(b). The pure FP response, f_{FP}(λ), 120 is then obtained through the application of a curve fitting algorithm to the FBG response suppressed spectrum, as shown in FIG. 6(c). The actual FBG response, f_{FBG}(λ), 105 is then recovered from the original combined spectrum using the relation:

$${f}_{FBG} ( λ ) = \frac{h ( λ ) - {f}_{FP} ( λ )}{1 - {f}_{FP} ( λ )}$$

It should be noted that an offset signal may be superimposed onto the reflection signal (not shown). This offset signal may or may not be dependent on the wavelength. If the offset signal exists then the above equation also stands, but f_{FP}(λ) would be replaced by the combined offset and f_{FP}(λ) function.

Furthermore, the pure FP signal, f_{FP}(λ), derived from the curve fitting to the FBG suppressed response can be used in its entirety as suitable information for deriving pressure, i.e., there is an option of using an entire spectral range rather than just one separate observation window to recover pressure because the FBG response has been suppressed.

As a result of this method, the two separated and mutually unaffected signals can be used to recover local temperature and pressure. These two signals are first recorded for a range of known temperatures and pressures into a look-up table. The look-up table is then used by the processor in the normal operation of the system to recover the measured values of pressure and temperature.

By providing the system with such algorithmic or model based signal separation capabilities, further separation of the signals 105, 120 from each signal sensing element 45, 75 can be obtained without bulky signal separation apparatus. By providing a combined sensor 20 having both temperature and pressure sensing elements, thereby measuring both temperature and pressure of the same measurement area, the above response separation methods can be employed with a great degree of accuracy.

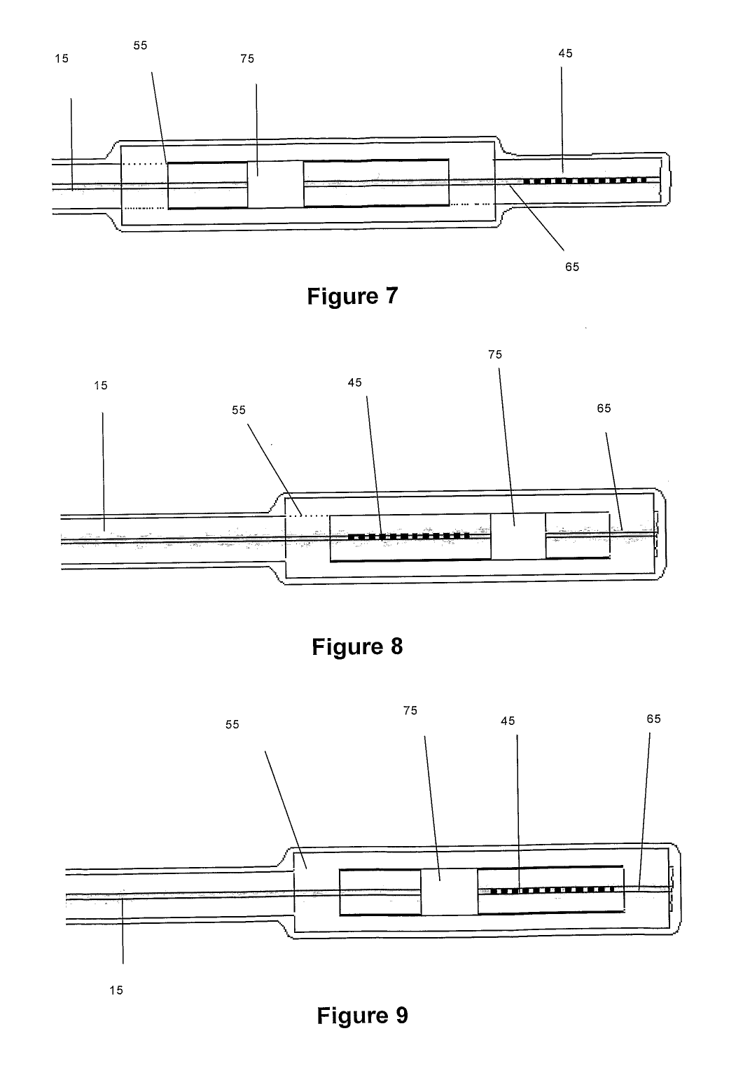

In the embodiment of FIG. 2(a), the FBG 45 is embedded in the first capillary 15 and, as such, light from the light source 25 passes through the FBG 45 before the FP cavity 75. In an alternate embodiment, as shown in FIG. 7, the FBG 45 is provided in the second optical fibre 65 such that the light from the source 25 passes through the FP cavity 75 before the FBG 45.

FIGS. 8 and 9 show a sensor in which the FBG 45 is located in a section of an optical fibre 15 or 65 that lies within the cavity 50 of the capillary 55, rather than adjacent to the capillary 55. Since the cavity 50 of the capillary 55 is sealed by bonding between the capillary 55 and the optical fibres 15, 65, changes of pressure outside the capillary 55 would have little influence on the response of the FBG 45. This results in a reduction of any error in the temperature measurement by the FBG 45 due to changes in external pressure. This arrangement may be used regardless of whether or not the FBG 45 is incorporated into the optical fibre 15 between the light source 25 and the FP 75 or in the second optical fibre 65, such that the FP cavity 120 is between the light source 25 and the FBG 45.

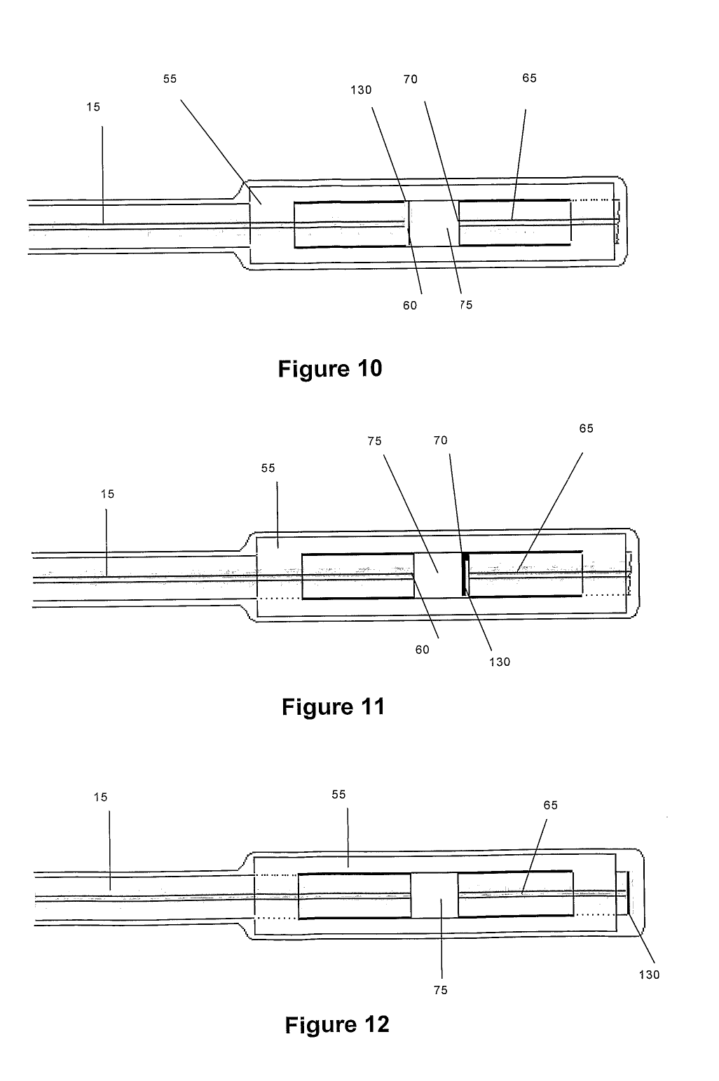

FIGS. 10 to 12 show alternate embodiments. In these embodiments, a Bragg reflector 130 is used in place of, or in addition to, the FBG 45. The Bragg reflector 130 comprises alternate layers of at least two different dielectric materials, such as silicon nitride and silicon reach silicon nitride or various combinations of silicon dioxide, silicon nitride, silicon oxynitride, cerium dioxide, titanium dioxide, or other suitable materials as would be contemplated by a person skilled in the art. The Bragg reflector 130 may be provided within the cavity 50 of the capillary 55 on either of the optical fibre 15 or 65 end surfaces 60 or 70 forming the FP cavity 75. Alternatively or additionally, it may be located external to the capillary 50, at an end of the second optical fibre 65 furthest from the light source 25, as shown in FIG. 10. Locating the Bragg reflector 130 within the cavity 50 of the capillary 55 provides reduced sensitivity to errors in temperature due to variations in pressure, as described above. Locating the Bragg reflector 130 external to the capillary 55 results in better contact between the Bragg reflector 130 and the surrounding environment, with a corresponding increase in the temporal response to temperature changes in the environment. Both of the above advantages can be realised by providing temperature sensing elements, such as Bragg reflector 130 and/or FBG 45 both internally and externally to the capillary 55 reflecting at two different peak wavelengths.

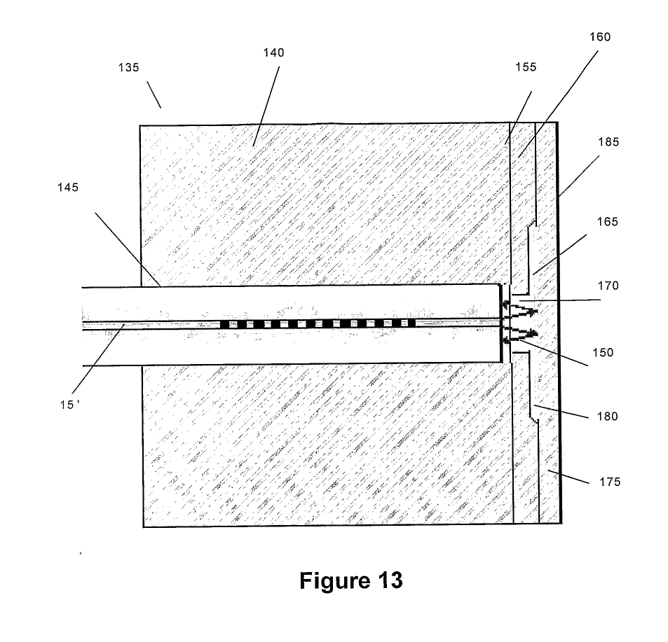

FIG. 13 shows another dual temperature and pressure sensor 20. This has a MEMS device 135 that comprises a substrate 140 having a bore 145 for accommodating an optical fibre 15′. The optical fibre 15′ is bonded into the bore 145, for example, by glass or metal solders or by polymer adhesive bonding. The bore 145 forms an opening 150 at least to a first surface 155 of the substrate 140. The optical fibre 15′ is a cleaved fibre, such that an end of the optical fibre 60 faces out from the opening 150 of the bore 145. The first surface 155 of the substrate 140 is provided with a spacer layer 160. The spacer layer 160 is provided with a recess 165 etched part way through the thickness of the spacer 160. The recess 165 surrounds a hole 170 through the spacer 160, the hole 170 being positioned coaxially with the opening 150 to the bore 145 in the substrate 140.

Bonded to the outer surface of the spacer 160 is a diaphragm 175 that seals the recess 165, but is unbonded to the recess 165 such that this portion of the diaphragm 175 is free to flex in response to changes in external pressure. The substrate 140, spacer 160 and diaphragm 175 are made of suitable materials as would be known to the skilled person, such as silicon or borosilicate glass. Each of the layers 140, 160, 175 can be formed integrally with each other or bonded to each other, for example by such as thermocompression bonding, electric field assisted bonding and polymer adhesive bonding.

Optionally, a reflective coating 180 such as a dielectric or metal coating can be applied to an inner surface of the diaphragm 175 that is opposite the end 60 of the optical fibre 15′, such that the inner surface of the diaphragm 175 and the end 60 of the optical fibre 15′ operate as an optical cavity 75. A Bragg reflector 130 is provided on the end 60 of the optical fibre 15′. Additionally or alternatively, a FBG 45 is provided in the optical fibre 15′, preferably in a portion of the optical fibre 15 that is encased within the substrate 140 so as to minimise pressure effects. The outer facing surface 185 of the diaphragm is provided with a non-reflective coating or is roughened, in order to eliminate the possibility of forming another FP cavity within the diaphragm boundaries, which could contaminate the overall spectral response.

The above MEMS based sensors 135 operate in the system 5 of FIG. 1 in similar fashion to those shown in FIGS. 2 and 5 to 10.

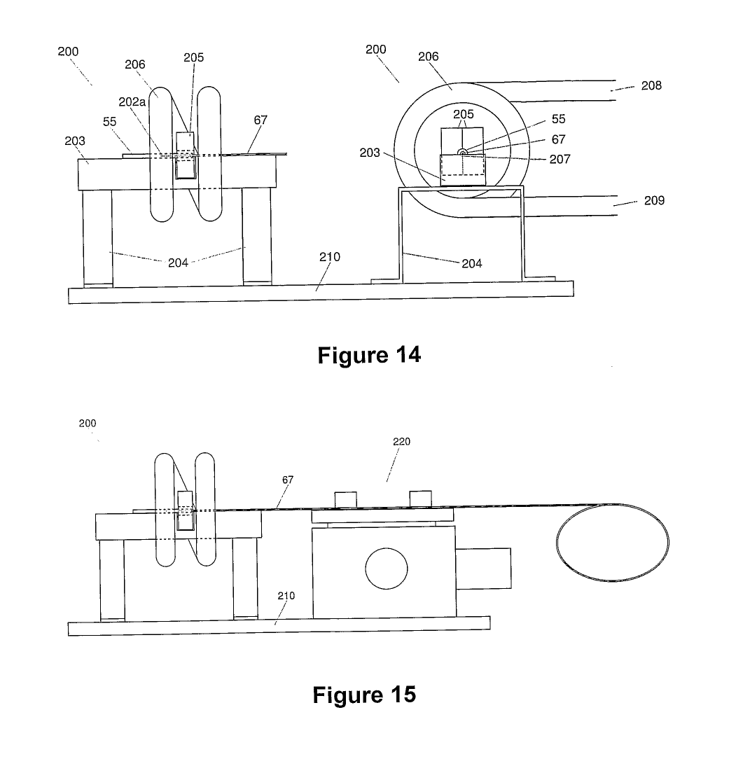

FIG. 14 illustrates a method of fabricating the combined pressure and temperature sensor 20. The method comprises providing a system 200 comprising a supported ceramic bench 203 with machined groves 207 to accommodate the capillary 15, metal-coated fibres 16, 65 and/or wire 67 and machined slots to accommodate at least one induction-heating element or metallic heat concentrating element 205 which is heated using induction methods, e.g., using a coil 206 energised by a high-frequency current flowing through the coil. The coil 206 is hollow and water or other liquid is pumped through it using inlet 208 and outlet 209.

The heat concentrating element 205 is arranged in two segments to surround a short section of the capillary 55 where a bond with metal-coated fibre 15, 65 or reflecting wire 67 is effected with the use of carefully applied brazing materials, e.g., metal paste or with the use of glass frit. The brazing material or glass frit melt under the heat generated by the heat concentrating element, which in turn is heated by eddy currents generated by the changing magnetic field that results from the high frequency current flowing through coil 206. Melted material reacts with the inner surface of capillary 55 and metal-coated fibre 15, 65 or wire 67 and forms a strong bond after cooling.

The frequency of current flowing through coil 206 is chosen such as to induce heat only in heat concentrator 205 and not in capillary 55 or metal coated fibre 15, 65. It is well known that low frequency magnetic fields penetrate deeper into a metallic element, and so the frequency can be chosen so that the field passes through the fibre coating and capillary wall depths without significant eddy current generation but generates significant eddy currents in heat concentrator 205, which is more bulky.

To ensure more uniform temperature across the cross-section of heat concentrator 205, its edges may be taken off or rounded. Furthermore, to reduce oxidisation of the capillary and fibre, inert gas such as argon or nitrogen may be blown at the area where heating takes place (not shown). Alternatively, the whole arrangement may be placed in a vacuum chamber.

FIG. 15 shows the use of a micro-positioning manipulator 220 together with the system 200, which can be used to hold fibre 15, 65 and/or reflecting wire 67 to assist in inserting the fibre 15, 65 and/or wire 67 in the capillary 55 and moving it to the required depth.

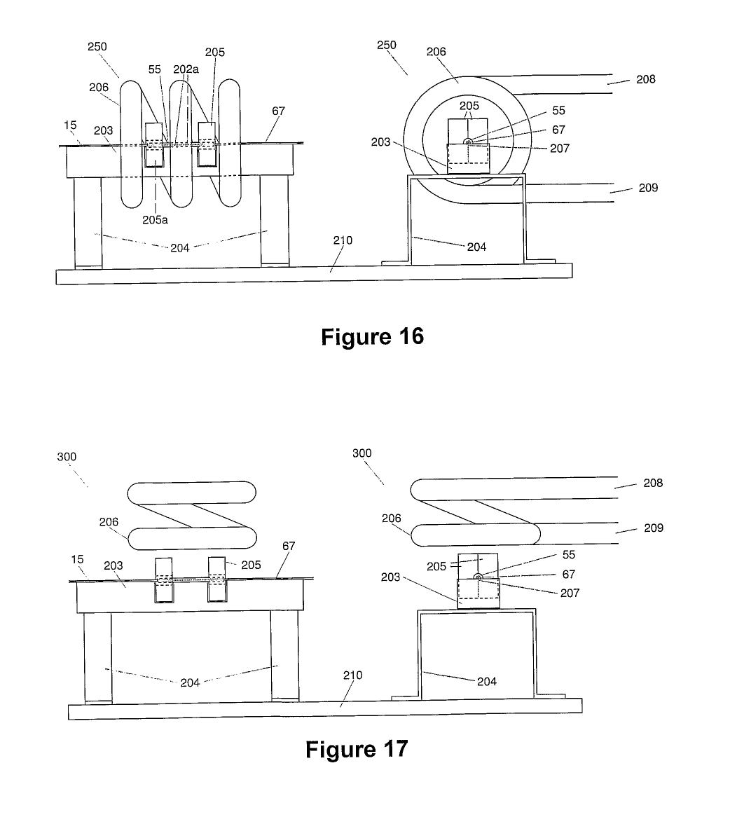

Furthermore, the system 200 can be adapted, as shown in FIG. 16, to facilitate heating of both sides of capillary 55 at the same time by using at least two heat concentrating elements 205 and 205a. Micro-positioning manipulators 220 may be arranged on both sides of the ceramic bench (not shown) which can be used to hold optical fibres 15, 65 and/or reflecting wire 67 to assist in inserting the fibre 15, 65 and/or wire 67 in the capillary 55 and moving them to the required depth. Moreover, capillary 55 may be held in place using an appropriate ceramic weight or clamp (not shown).

FIG. 17 shows an alternative arrangement in which the axis of induction coil 206 is positioned perpendicular to capillary 55, either above heat concentrator elements 205, as shown in FIG. 17, or underneath or at the side (not shown). In this case, there is greater freedom to manipulate the sensor 20 during production, as the arrangement is not surrounded by the coil.

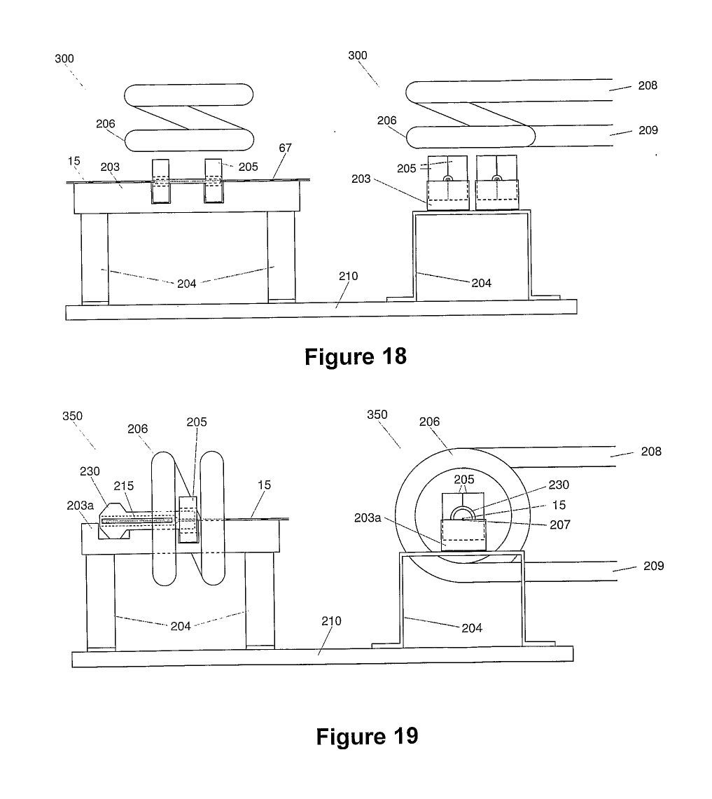

Furthermore, as shown in FIG. 18, the system can be further adapted to facilitate heating multiple sensor elements 20 during production by providing two or more ceramic benches and multiple heat concentrating elements heated with just one induction coil.

FIG. 19 shows the method of sealing combined sensor 20 within an enclosure 90 in the form of a round metal plug 230 which can be secured in a port of a pressurised system using an appropriate gland. The protruding end of plug 230 is drilled to accommodate metal-coated fibre 15 that forms a pigtail of the combined sensor 20. Brazing material is applied to the drilled hole and a short section of fibre 15, and the protruding end of plug 230 is heated using a heat concentrator arranged around a short section of the protruding end. The heat concentrator is heated via induction heating methods, e.g. using coil 206, carrying a high-frequency current. The melted brazing material bonds to plug 230 and fibre 15′ and forms a high-pressure metallic seal upon cooling.

A skilled person will appreciate that variations of the disclosed arrangements are possible without departing from the invention. For example, whilst embodiments above describe the temperature sensing element as being either a FBG 45 or a Bragg reflector 130, in practice the two types of sensing element can be used interchangeably or in conjunction with one another. Accordingly the above description of the specific embodiment is made by way of example only and not for the purposes of limitation. It will be clear to the skilled person that minor modifications may be made without significant changes to the operation described.

1. A combined pressure and temperature sensor, the sensor comprising at least one first optical sensing element of a first type and at least one second optical sensing element of a second type, wherein the sensor is adapted to compensate for temperature and/or pressure effects in the first or second optical sensing element using a response of the other of the second or first optical sensing elements.

2. A combined pressure and temperature sensor, the sensor comprising at least one first optical sensing element of a first type and at least one second optical sensing element of a second type, wherein, at least one of the first and/or second sensing elements is arranged to produce a response to temperature and/or pressure in a different wavelength range to a response to temperature and/or pressure produced by the other sensing element.

3. A combined pressure and temperature sensor, the sensor comprising at least one first optical sensing element of a first type and at least one second optical sensing element of a second type, wherein at least one of the first and/or second optical sensing elements is a narrow-band sensing element.

4. A combined pressure and temperature sensor according to claim 2, wherein the sensor is adapted to compensate for temperature and/or pressure effects in the first or second optical sensing element using a response of the other of the second or first optical sensing elements.

5. A combined pressure and temperature sensor according to claim 1, wherein at least one of the first and/or second sensing elements is arranged to produce a response to temperature and/or pressure in a different wavelength range to the response to temperature and/or pressure produced by the other sensing element.

6. A combined pressure and temperature sensor according to claim 1, wherein at least one of the first and/or second optical sensing elements is a narrow-band sensing element.

7. A combined pressure and temperature sensor according to claim 1, wherein the first optical sensing element comprises an optical cavity, such as a Fabry-Perot cavity.

8. A combined pressure and temperature sensor according to claim 1, wherein the second optical sensing element comprises a Bragg grating or a Bragg reflector, which may be a narrow band Bragg grating or Bragg reflector.

9. A combined pressure and temperature sensor according to claim 3, wherein the narrow-band optical sensing element is arranged to produce a response having a full width half maximum (FWHM) of less than 2 nm and preferably between 0.2 nm and 0.7 nm.

10. A combined pressure and temperature sensor according to claim 1, wherein the sensor is adapted to measure temperature and pressure of substantially the same area.

11. A combined pressure and temperature sensor according to claim 1, wherein the first and second optical sensing elements are substantially proximate or adjacent each other.

12. A combined pressure and temperature sensor according to claim 1, wherein the first optical sensing element is adapted to be more responsive to pressure than the second optical sensing element.

13. A combined pressure and temperature sensor according to claim 1, wherein the second optical sensing element is adapted to be more responsive to temperature than the first optical sensing element.

14. A combined pressure and temperature sensor according to claim 7, wherein the cavity is sealed.

15. A combined pressure and temperature sensor according to claim 8, wherein the fibre Bragg grating and/or Bragg reflector are formed in, or on, an optical fibre.

16. A combined pressure and temperature sensor according to claim 8, wherein the Bragg reflector comprises alternate layers of at least two different dielectric materials.

17. A combined pressure and temperature sensor according to claim 1, wherein the sensor is adapted to collect data over a continuous spectral range.

18. A combined pressure and temperature sensor according to claim 1, wherein the first optical sensing element is arranged to have a low reflectivity relative to the second optical sensing element.

19. A combined pressure and temperature sensor according to claim 1, wherein the reflectivity of the first optical sensing element is 8% or less.

20. A combined pressure and temperature sensor according to claim 1, wherein at least one first and/or second optical sensing element is located within a housing.

21. A combined pressure and temperature sensor according to claim 20, wherein at least one second optical sensing element is located external to and adjacent the housing.

22. A combined pressure and temperature sensor according to claim 1, wherein the sensor comprises at least a first optical fibre and a pressure sensitive housing, the housing defining a cavity, wherein an end of the first optical fibre is located within the cavity; the end of the first optical fibre being located such that it faces an end of a second optical fibre and/or a reflective surface so as to form the optical cavity.

23. A combined pressure and temperature sensor according to claim 22, wherein the pressure sensitive housing is deformable by outside pressure so as to change at least one dimension of the cavity.

24. A combined pressure and temperature sensor according to claim 22, wherein the reflective surface is a metal surface such as an end of a metal rod.

25. A combined pressure and temperature sensor according to claim 1, wherein the sensor is a microelectromechanical system (MEMS) device.

26. A combined pressure and temperature sensor according to claim 25, wherein the sensor comprises a base layer enclosing an end of an optical fibre, a spacer layer disposed on the base layer, the spacer defining a through opening adjacent to the end of the optical fibre and a diaphragm on a surface of the spacer opposite the base layer, such that the end of the first optical fibre, the base layer, the spacer and the diaphragm form a sealed cavity.

27. A combined pressure and temperature sensor according to claim 26, wherein the surface of the diaphragm facing the end of the first optical fibre is provided with a reflective surface, so as to form an optical cavity with the end of the optical fibre.

28. A combined pressure and temperature sensor according to claim 27, wherein the reflective surface is a metal or dielectric reflective surface.

29. A combined pressure and temperature sensor according to claim 27, wherein the diaphragm is provided with an antireflective coating on an opposite side to the reflective surface.

30. A combined pressure and temperature sensor according to claim 29, wherein the antireflective coating is a roughened or angle ground surface of the diaphragm.

31. A combined pressure and temperature sensor according to claim 26, wherein the base layer and/or spacer and/or diaphragm are constructed from silicon or borosilicate glass.

32. A combined pressure and temperature sensor according to claim 22, wherein the housing and/or at least one optical fibre has a water resistant coating, such as a polyiamide coating.

33. A combined pressure and temperature sensor according to claim 1, wherein the housing and/or reflective surface and/or optical fibre may be adapted such that the cavity length remains substantially unchanged with varying temperature.

34. A system comprising a combined pressure and temperature sensor and a sensor interrogation system, the sensor comprising at least one first optical sensing element of a first type and at least one second optical sensing element of a second type, wherein the sensor interrogation system is adapted to compensate for temperature and/or pressure effects in the first or second optical sensing element using a response of the other of the second or first optical sensing elements.

35. A system comprising a combined pressure and temperature sensor and a sensor interrogation system, the sensor comprising at least one first optical sensing element of a first type and at least one second optical sensing element of a second type, and the sensor interrogation system being adapted to deconvolute the responses of each sensing element using an algorithmic compensation technique and/or model fitting and/or curve fitting.

36. A system comprising a combined pressure and temperature sensor and a sensor interrogation system, the sensor comprising at least one first optical sensing element of a first type and at least one second optical sensing element of a second type, and the sensor interrogation system being adapted to suppress a response produced by of one of the first or second optical sensing elements to produce a modified response and determine pressure and/or temperature based on the modified response.

37. A system according to claim 34, wherein the combined pressure and temperature sensor is a sensor wherein the sensor is adapted to compensate for temperature and/or pressure effects in the first or second optical sensing element using a response of the other of the second or first optical sensing elements.

38. A system according to claim 35, wherein the sensor interrogation system is adapted to compensate for temperature and/or pressure effects in the first or second optical sensing element using a response of the other of the second or first optical sensing elements.

39. A system according to claim 34, wherein the sensor interrogation system is adapted to deconvolute the responses of each sensing element using an algorithmic compensation technique and/or model fitting and/or curve fitting.

40. A system according to claim 34, wherein the sensor interrogation system is adapted to suppress a response produced by of one of the first or second optical sensing elements to produce a modified response and determine pressure and/or temperature based on the modified response.

41. A system according to claim 34, comprising a light source.

42. A system according to claim 41, wherein the light source is a broadband light source.

43. A system according to claim 41, wherein the light source is a superluminescent diode or a superfluorescent source or a tunable laser.

44. A system according to claim 41, wherein the light source is a non-pulsed light source.

45. A system according to claim 41, wherein the system is adapted to measure a continuous spectral range.

46. A system according to claim 34, wherein the system is adapted to determine the influence of the first or second sensing element on the other of the first or second sensing element by comparing the experimental data to calibration or modelled data.

47. A method for determining temperature and/or pressure at a location, comprising providing a sensor according to claim 1 at the location and extracting a response produced by the first optical sensing element and/or a response produced by the second optical sensing element in order to obtain a response of the sensor indicative of temperature and/or pressure.

48. A method according to claim 47, wherein the method comprises using the extracted response produced by the first or second optical sensing element to compensate for pressure or temperature effects on the other of the second or first optical sensing element.

49. A method according to claim 47, wherein the method comprises determining the influence of one of the first or second optical sensing element on the other of the first or second optical sensing element by comparing the experimental data to calibration or modelled data.

50. A method according to claim 47, wherein the method comprises deconvoluting the responses of each sensing element.

51. A method according to claim 50, wherein the deconvolution is via an algorithmic compensation technique.

52. A method according to claim 51, wherein the deconvolution comprises capturing a combined spectrum from at least two sensing elements and employing an algorithmic technique to suppress the response of at least one of the sensing elements in order to determine the response of at least one other of the sensing elements.

53. A method of bonding an optical fibre and/or wire, the method comprising providing bonding material in a bonding region between at least a portion of the optical fibre and/or wire and at least a portion of an object, providing a metallic induction-heating element proximate the bonding region and heating the induction-heating element using inductive heating to bond the optical fibre and/or wire to the object.

54. A method according to claim 53, wherein the bonding comprises brazing and the bonding material comprises a brazing material.

55. A method according to claim 53, wherein the object is a pressure sensitive housing, such as a capillary.

56. A method according to claim 53, wherein the metallic induction heating element and/or the bonding region may be sized such that heating by the metallic induction-heating element and/or bonding is localised to the bonding region.

57. A method according to claim 53, wherein the metallic induction-heating element is inductively heatable by an induction source, such as a coil.

58. A method according to claim 57, wherein the induction source is operable using a current having a frequency of less than 1 MHz, optionally less than 400 kHz, such as between 300 and 400 kHz.

59. A method according to claim 53, wherein, the induction-heating element is arranged to surround an optical fibre and/or wire and/or capillary.

60. A method according to claim 53, wherein the induction-heating element defines a passage for receiving an optical fibre and/or wire and/or capillary.

61. A method according to claim 53, wherein the induction-heating element is provided in two or more pieces.

62. A method according to claim 53, wherein inert gas such as argon or nitrogen is provided at the area where heating takes place.

63. A method of fabricating an optical sensing element for a sensor, the method comprising bonding at least a portion of at least one optical fibre and/or wire to a pressure sensitive housing the method of claim 53, in order to form at least one of the first and/or second optical sensing elements.

64. Apparatus for performing a method according to claim 53, the system comprising one or more induction-heating element defining a passage for receiving at least a section of an optical fibre and/or a wire and/or a pressure sensitive housing, and at least one induction source for causing heating of the one or more induction-heating elements by induction.

65. Apparatus according to claim 64, wherein the induction-heating element is adapted to be heated by eddy currents generated by a changing magnetic filed resulting from a high frequency current flowing through a coil.

66. Apparatus according to claim 64, wherein the induction-heating element is provided in two or more pieces.

67. Apparatus according to claim 64, comprising a bench, which may be a ceramic bench, the bench comprising one or more grooves for accommodating at least one optical fibre and/or wire and/or pressure sensitive housing and/or slots for accommodating at least one induction-heating element.

68. Apparatus according to claim 64, comprising one or more micro-positioning manipulators operable to hold and/or move optical fibres and/or wire.

69. A method of sealing a sensor according to claim 1 within a plug for securing in a port of a pressurised system using a gland, the method comprising drilling a hole in an end of the plug for an optical fibre, applying brazing material to the hole and/or the fibre, heating the end of the plug using an induction-heating element arranged around a section of the end to bond and seal the plug and fibre.

70. A plug for securing in a port of a pressurised system using a gland, the plug containing a sensor according to claim 1.

71. A computer program product adapted to implement a sensor of claim 1.

72. A computer program product adapted to implement a system of claim 34.

73. A computer program product adapted to implement a method of claim 47.

74. A computer program product adapted to implement an apparatus according to claim 64.
